(19) United States
(12) Patent Application Publication
(10) Pub. No.: US 2012/0027453 A1
(43) Pub. Date: Feb. 2, 2012

(54) IMAGE FORMING APPARATUS

(75) Inventors: Toshiyuki Watanabe, Yokohama-shi (JP); Yuichiro Inaba, Chigasaki-shi (JP); Keisuke Ishizumi, Mishima-shi (JP)

(73) Assignee: CANON KABUSHIKI KAISHA, Tokyo (JP)

(21) Appl. No.: 13/192,811

(22) Filed: Jul. 28, 2011

(30) Foreign Application Priority Data
Jul. 30, 2010 (JP) 2010-171816

(51) Int. Cl. G03G 15/16

(52) U.S. Cl. 399/101

(57) ABSTRACT

An image forming apparatus includes an image bearing member; a rotatable intermediary transfer member; first transfer member; a second transfer member toner images transferred and superposed on the intermediary transfer member onto a transfer material at a second transfer position; a charging member provided downstream of the second transfer position and upstream of the first transfer position; a first voltage source portion for applying a voltage to the charging member; a charging brush provided downstream of the second transfer position and upstream of the charging member with respect to the rotational moving direction; and a second voltage source portion for applying a voltage to the charging brush, wherein second voltage source portion is capable of applying voltage to the charging brush in a state that a voltage is applied to the charging member by first voltage source portion; and a regulating member, provided between the charging member and the charging brush with respect to the rotational moving direction, for regulating a position of a brush of the charging brush.

### FIELD OF THE INVENTION AND RELATED ART

The present invention relates to an image forming apparatus of an electrophotographic type such as a copying machine, a laser beam printer or a facsimile machine.

An intermediary transfer type image forming apparatus in which a toner image formed on an image bearing member is once transferred onto an intermediary transfer member, and then, is transferred onto a transfer material, is characterized in that it can form images on various transfer material. The type is therefore used for a color image forming apparatus in which a plurality of color images are superposed.

For a method for collecting the toner deposited on the intermediary transfer member from such an intermediary transfer member, a fur brush cleaning or blade cleaning are used.

Japanese Laid-open Patent Application 2009-205012 discloses a structure in which a charging brush and a charging roller as a charging member are provided between the primary transfer portion and the secondary transfer portion to collect the toner from the intermediary transfer member. The toner scattered on the intermediary transfer member by the charging brush is charged by the charging roller, by which deposited toner can be efficiently transferred onto the photosensitive drum from the intermediary transfer member at the primary transfer portion.

The free ends of the brush of the charging brush are in a free state, and therefore, if the voltage is applied in the state that the charging brush is spaced from the intermediary transfer member, the current may leak from the free ends of the brush member to the structural member therearound.

It would be considered that to provide a sufficient insulation distance to avoid the leakage, but then a complicated spacing mechanism would be required, or the main assembly of the image forming apparatus would be upsized.

In addition, in the case that the voltage source for applying a voltage to the charging means is commonly used as another structural member such as a voltage source for transfer bias voltage, the voltage may be applied also when the charging means is spaced for the purpose of maintaining a printing speed equivalent to that when the voltage source exclusively for the charging means is provided.

### SUMMARY OF THE INVENTION

Accordingly, it is a principal object of the present invention to provide an image forming apparatus, comprising an image bearing member for carrying a toner image; a rotatable intermediary transfer member; a first transfer member for transferring the toner image formed on said image bearing member onto said intermediary transfer member at a first transfer position; a second transfer member for transferring toner images transferred and superposed on said intermediary transfer member onto a transfer material at a second transfer position; a charging member provided downstream of the second transfer position and upstream of the first transfer position with respect to the rotational moving direction of said intermediary transfer member; a first voltage source portion for applying a voltage to said charging member; a charging brush provided downstream of the second transfer position and upstream of said charging member with respect to the rotational moving direction; a second voltage source portion for applying a voltage to said charging brush, wherein second voltage source portion is capable of applying voltage to said charging brush in a state that a voltage is applied to said charging member by first voltage source portion; and a regulating member, provided between said charging member and said charging brush with respect to the rotational moving direction, for regulating a position of a brush of said charging brush.

These and other objects, features and advantages of the present invention will become more apparent upon a consideration of the following description of the preferred embodiments of the present invention taken in conjunction with the accompanying drawings.

### BRIEF DESCRIPTION OF THE DRAWINGS

FIG. 1 is a schematic sectional view of an image forming apparatus according to an embodiment of the present invention.

FIG. 2 is an enlarged sectional view illustrating structures around an intermediary transfer member in the image forming apparatus of FIG. 1.

FIG. 3 is a schematic view illustrating contacted state of charging means for intermediary transfer member cleaning in a comparison example.

FIG. 4 is an illustration of the comparison example in which charging means for the intermediary transfer member cleaning is in a spaced state.

FIG. 5 is an illustration of a first embodiment of the present invention in which the charging means for the intermediary transfer member cleaning is in the contact state.

FIG. 6 is an illustration of the first embodiment of the present invention in which the charging means for the intermediary transfer member cleaning is in the spaced state.

FIG. 7 is an illustration of a second embodiment of the present invention in which the charging means for the intermediary transfer member cleaning is in the contact state.

FIG. 8 is an illustration of the second embodiment of the present invention in which the charging means for the intermediary transfer member cleaning is in the spaced state.

### DESCRIPTION OF THE PREFERRED EMBODIMENTS

An image forming apparatus according to an embodiment of the present invention will be described in conjunction with the accompanying drawings. Here, the dimensions, the sizes, the materials, the configurations, the relative positional relationships of the elements in the following embodiments and examples are not restrictive to the present invention unless otherwise stated.

### Embodiment 1

### General Arrangement of Image Forming Apparatus

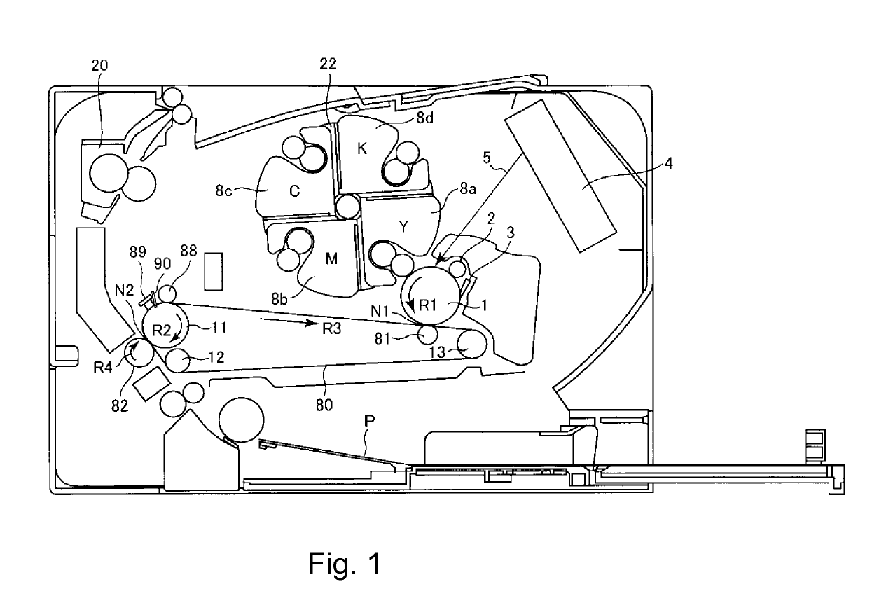

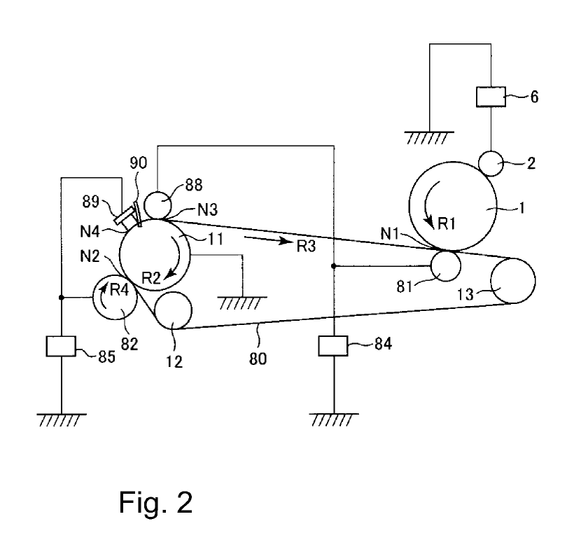

FIGS. 1 and 2 illustrate a substantial structure according to an embodiment of the present invention. An example of the image forming apparatus according to this embodiment is a color image forming apparatus of a four-path superimposing transfer type using an intermediary transfer belt as an intermediary transfer member.

The image forming apparatus of this embodiment comprises a drum type electrophotographic photosensitive member (photosensitive drum) as an image bearing member. Around a peripheral surface of the photosensitive drum 1, there are provided a charger 2, exposure unit 4 for irradiating the photosensitive drum 1 with a laser beam, a developing unit, an intermediary transfer belt 80 as intermediary transfer member and a photosensitive drum cleaning unit 3 arranged in the order named in the direction R1 in the Figure. The developing unit 8 is a rotary type development unit in this embodiment, and includes a rotary 22 (rotatable member) carrying four color developing devices 8a, 8b, 8c, 8d. The rotary 22 is controlled by unshown driving means to bring a predetermined developing device to a developing position where the developing device faces the photosensitive drum 1.

The photosensitive drum 1 is rotated in the rotational moving direction R1 at a surface speed of 100 mm/sec, and the surface thereof is charged to the negative polarity by the charger 2. The charger 2 is supplied with a charging bias voltage comprising a DC voltage component and an alternating voltage component by a charger voltage source. The potential of the surface of the photosensitive drum 1 charged by the charger 2 is ordinarily about −500V.

On the surface of the charged photosensitive drum 1, an electrostatic latent image is formed by exposure 5 by the exposure unit 4 in accordance with image information. Here, the exposure unit 3 comprises a light source such as a laser, 6-surface polygonal mirror for raster scanning, an imaging lens, a fold-back mirror or the like. The electrostatic latent image is visualized with yellow toner charged negative by the yellow (first color) developing device 8a which is positioned at the developing position by the rotary 22 of the developing unit 8, into a toner image.

The intermediary transfer belt 80 is supported by a plurality of supporting rollers including a driving roller 11, an assisting roller 12 and a tension roller 13. The intermediary transfer belt 80 comprises an endless resin material belt having a thickness of 0.05 mm-0.3 mm and having a resistance adjusted to a volume resistivity of about 10⁷-10¹¹ Ωcm by electroconductive filling material such as carbon, ZnO, SnO2, TiO2 or the like. Here, the material of the resin material belt may be PVdF (polyvinylidene fluoride), Nylon, PET (polyethylene terephthalate), PEN (polyethylenenaphthalate), PI, PEEK, PPS, polycarbonate, for example.

With rotation of the driving roller 11 in the direction R2 in the Figure, the intermediary transfer belt 80 rotates in the direction R3 in the Figure. A primary transfer roller 81 as first transferring means is disposed at a first transfer position and is driven by the intermediary transfer belt 80 and is supplied with a primary transfer bias of a positive polarity from a bias voltage source 84. By this, the toner image on the photosensitive drum 1 is primary-transferred onto the intermediary transfer belt 80 through a primary transfer nip N1. Here, the primary transfer bias is a DC voltage. Ordinarily, the primary transfer roller 81 comprises an EPDM, urethane rubber, CR, NBR or the like which is added with resistance adjusting material such as carbon to adjust the volume resistivity thereof.

From the surface of the photosensitive drum 1 after the primary transfer, primary untransferred toner is removed by a photosensitive drum cleaning unit 3 including an elastic blade.

The above-described a series of image forming process including charging, exposure, development, primary transfer and cleaning is carried out by the developing devices 8b, 8c and 8d using second color (magenta) toner, third color (cyan) toner and fourth color (black) toner. More particularly, the rotary 22 is rotated to bring the respective development devices to the developing position, and four color toner images are overlaid on the intermediary transfer belt 80.

Then, a secondary transfer bias of the positive polarity is applied from a bias voltage source 85 to a secondary transfer roller 82 as a second transferring means rotating in the R4 in the Figure and disposed in the second transfer position. By this, the toner image on the intermediary transfer belt 80 is secondary-transferred all together onto a surface of the transfer material P through a secondary transfer nip N2 on the secondary transfer opposing roller 86. The secondary transfer bias is a DC voltage.

The transfer material P carrying the toner image is fed to the fixing device 20, where the toner image is fixed, thus completing the image formation.

On the other hand, later the completion of the above-described secondary transfer, the deposited toner remaining on the intermediary transfer belt 80 not having been transferred to the transfer material P comes to the position where a charge portion brush 89 and a charging member 88 are provided. The charging member 88 is desirably a charging roller for the reason which will be described hereinafter, but similarly to the charging brush, it may be a brush member.

Here, the charging brush 89 and the charging roller 88 are provided between the secondary transfer roller 82 and the primary transfer roller 81 and are opposed to the intermediary transfer belt 80. The charging roller 88 is disposed downstream of the charging brush 89 with respect to the moving direction of the intermediary transfer belt 80.

The charging brush 89 and the charging roller 88 are supplied with the voltages from the 85 and the positive bias voltage source, respectively, in this embodiment. The bias voltage source 84 functions as both of bias voltage sources for the primary transfer roller 81 (primary transfer bias voltage) and the charging roller 88. The bias voltage source 85 functions as bias voltage sources for the secondary transfer roller 82 (secondary transfer bias) and for the charging brush 89.

The functions of the charging brush 89 and the charging roller 88 will be described.

In this embodiment, the charging brush 89 is made of Nylon, and fineness thereof is 7 decitex, pile length is 5 mm, brush width is 5 mm, and the electric resistance is 10⁶ Ω.

Most of the toner deposited on the intermediary transfer belt 80 is charged to the polarity (positive) opposite the regular charge polarity (negative in this embodiment). However, not all the deposited toner is charged to the positive, a part of the toner is neutralized (no charge), and the other remains negative. In addition, the deposited toner is overlaid on the intermediary transfer belt 80 as multiple layers. The multi-layer toner is not easily charged uniformly by the charging roller.

Therefore, the deposited toner on the intermediary transfer belt 80 is first dispersed on the intermediary transfer belt 80 by the charging brush 89. By the dispersion, the deposited toner on the intermediary transfer belt 80 is made a single layer toner, and therefore, the toner is relatively easily charged by the charging roller 88 disposed downstream. Furthermore, by applying a positive voltage to the charging brush 89, a part of the negative toner of the deposited toner on the intermediary transfer belt 80 can be recovered by the charging brush 89. By doing so, the amount of the toner passing by the charging roller 88 can be reduced. In addition, by applying the positive voltage to the charging brush 89, not only the negative toner is recovered, but also an electric discharge is produced between the charging brush 89 and the deposited toner, by which the toner is charged to the positive polarity. By doing so, the charging efficiency of the deposited toner by the charging roller 88 can be further improved.

In this manner, the charging brush 89 can stabilize the toner charging of the charging roller 88, and therefore, better cleaning property can be assured.

In this embodiment, the charging roller 88 is made of NBR rubber in which carbon black is dispersed to provide a volume resistivity of about 1.0×10⁸ Ωcm, the rubber being provided on a core metal. Moreover, the surface of the roller is abraded up to approx. Rz0.2 μm. When the after-secondary-transfer residual toner is charged, it is contacted to the intermediary transfer belt 80 using the contacting-spacing unit 51, the driving roller 11 is contacted to a back side of the intermediary transfer belt 80 at the nip N3 and the nip N4 is grounded to increase the charging efficiency. The charging roller 88 (charging member) may be a brush member if it can charge the untransferred toner uniformly.

The deposited toner recharged by the charging brush 89 and the charging roller 88 to the positive polarity moves electrostatically to the photosensitive drum 1 (back-transfer) in the primary transfer nip N1, that is, the deposited toner remaining on the intermediary transfer belt 80 is removed. The deposited toner returned onto the photosensitive drum 1 is scraped off by the photosensitive drum cleaner 3 and it is recovered It is a possible alternative that the deposited toner recharged to the positive polarity by the charging brush 89 and the charging roller 88 is moved electrostatically to the photosensitive drum 1 simultaneously with the primary transfer of the next toner image

### Contacting and Spacing of Charging Member for Intermediary Transfer Member Cleaning

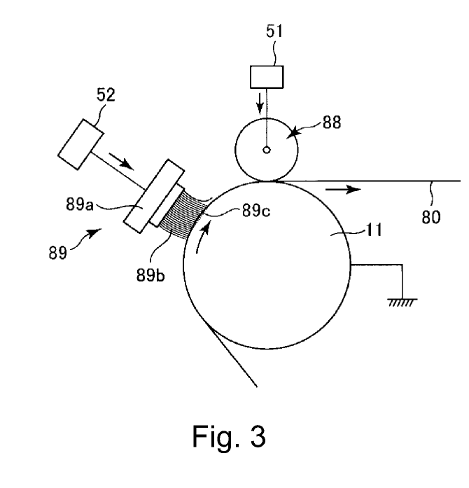

Referring to FIGS. 3-6, the operation of contacting and spacing of the charging member for the cleaning will be described. In the image forming apparatus of the embodiment, the charging brush 89 and the charging roller 88 are contacted to the intermediary transfer belt 80 only during the cleaning operation for the intermediary transfer belt 80. During image forming process in which the toner images being superimposedly transferred onto the intermediary transfer belt 80, they are spaced from the intermediary transfer belt 80.

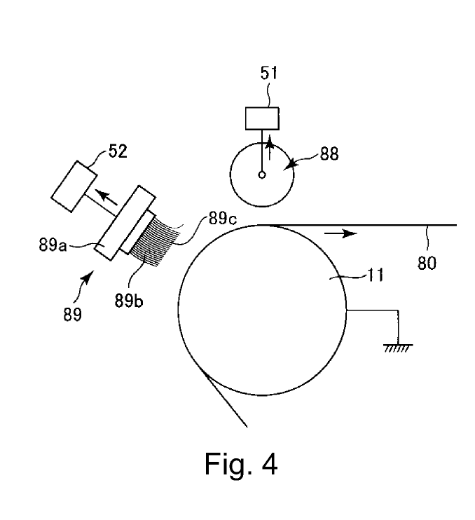

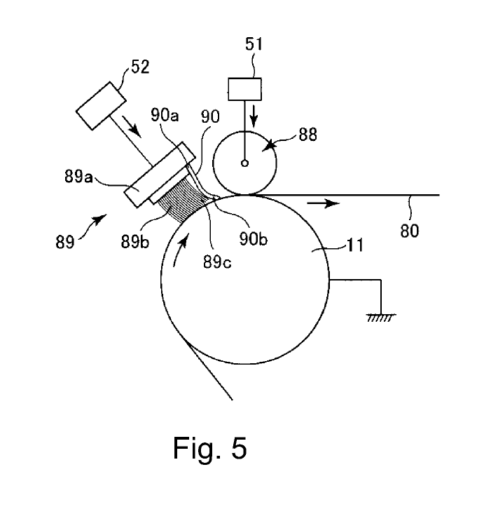

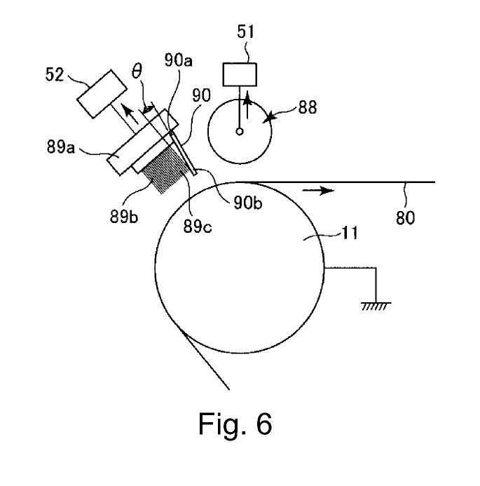

FIG. 3 and FIG. 4 illustrate contacted and spaced state of the charging member for the intermediary transfer member cleaning. FIG. 5 and FIG. 6 illustrate the contacted state and the spaced state of the charging member for the intermediary transfer member cleaning according to this embodiment.

In FIG. 3 and FIG. 5, the charging brush 89 and charging roller 88 are contacted to the intermediary transfer belt 80. As shown in FIG. 2, the charging brush 89 is supplied with a DC voltage from the bias voltage source 85 which is a common voltage source also for the secondary transfer bias, and the charging roller 88 is supplied with a DC voltage from the bias voltage source which is a common voltage source also for the primary transfer bias.

FIG. 4 and FIG. 6 are illustrations in the case that the charging brush 89 and the charging roller 88 are spaced from the intermediary transfer belt 80. The charging brush 89 and the charging roller 88 are moved from the contacted state to the spaced state relative to the intermediary transfer belt 80 by respective contacting-spacing units 52, 51 using solenoids or the like by predetermined distances.

In this embodiment, as described hereinbefore, the charging brush 89 is supplied with a DC voltage from the bias voltage source 85 which is a common voltage source also for the secondary transfer bias. The charging roller 88 is supplied with a DC voltage from the bias voltage source 84 which is a common voltage source also for the primary transfer bias. Therefore, in this embodiment, in the primary transfer step or in the secondary transfer step, a voltage may be applied when the primary transfer step and the charging roller 88 are spaced from the belt. In view of this, additional voltage sources for the provision and the charging roller 88 may be provided, so that the charging brush 89 and the charging roller 88 are not supplied with voltages when they are spaced from the belt.

In addition, the distances and directions with which the charging brush 89 and the charging roller 88 are spaced from the intermediary transfer belt 80 may be different from each other.

FIGS. 3 and 4 illustrate contacting and spacing operation states in the case of comparison example. FIGS. 5 and 6 illustrate contacting and spacing operation state in the case that a sheet 90 of this embodiment for regulating attitudes of the fur ends.

As shown in FIG. 3, when the charging brush 89 is contacted to the intermediary transfer belt 80, the charging brush 89 receives a force in the moving direction of the intermediary transfer belt 80, and therefore, the free ends 89c of the charging brush 89 bends in the moving direction of the intermediary transfer belt 80.

When there is a potential difference between the bias voltages applied to the charging brush 89 and to the charging roller 88, a leak current flows unless a sufficient insulation distance is provided between the charging brush 89 and the charging roller 88. For example, when the voltage source for the bias voltage to be applied to the charging brush 89 is common to the voltage source for the secondary transfer bias, the potential difference is larger than that in the charging roller 88 for which the voltage source is common with the voltage source for the primary transfer bias. Generally, the secondary transfer bias is higher than the primary transfer bias taking the resistance of the transfer material into consideration, and therefore, when the voltages are applied to the charging brush 89 and the charging roller 88, a potential difference results between them.

And wherein FIG. 4, when the charging brush 89 is spaced from the intermediary transfer belt 80, and there is a potential difference between the bias voltages applied to the charging brush 89 and to the charging roller 88, an electrostatic attraction force is produced, with the result that the free ends 89c of charging brush 89 bend toward the charging roller 88. Similarly to the case of contact, a leak current produces unless the insulation distance between the charging brush 89 and the charging roller 88 is sufficient.

Referring to FIGS. 5 and 6, there is shown a charging member comprising a charging brush 89 and a charging roller 88. In this embodiment, the brush 89b of the charging brush 89 is supported by a holding member 89a, and the holding member 89a is connected to the contacting-spacing unit 52. The contacting-spacing unit 52 functions to move the holding member by a solenoid, for example. In addition, in this embodiment, there is provided a regulating member 90 for regulating the attitude of the fur ends 89c of the charging brush 89. The regulating member 90 is in the form of a sheet. FIGS. 5 and 6 illustrate contacted and spaced states between the charging brush 89 and the charging roller 88 according to this embodiment.

The sheet 90 is disposed downstream of the charging brush 89 with respect to the feeding direction (moving direction) of the intermediary transfer belt 80, and in order to regulate the attitude of the fur ends 89c of the brush 89b, the sheet 90 is contacted to the brush 89b with a angle θ, as shown in FIG. 6, and an upper portion 90a of the sheet 90 is fixed to the holding member 89a. In this embodiment, the free end 90b of the sheet 90 is slightly projected toward the intermediary transfer belt 80 beyond the fur ends of the brush 89b.

In this embodiment, as described hereinbefore, the sheet 90 is fixed to a member 89a to which the brush 89b is fixed, and when the charging brush 89 is moved toward and away from the intermediary transfer belt 80, the relative positional relation between the sheet 90 and the charging brush 89.

Since the sheet 90 contacts the intermediary transfer belt 80, it is made of thin polyurethane film, for example, which has a relatively lower rigidity to avoid damage resulting from sliding contact to the surface of the intermediary transfer belt 80. Therefore, as shown in FIG. 5, when the charging brush 89 is in contact with the intermediary transfer belt 80, the free ends (free end portion 90b) of the sheet 90 are bent in the moving direction of the intermediary transfer belt 80, and the free ends 90b of the sheet 90 are contacted to the free end portions 89c of the brush 89b with the angle.

Therefore, as shown in FIG. 5, when the charging brush 89 is in contact with the intermediary transfer belt 80, the force is applied in the moving direction of the intermediary transfer belt 80, and therefore, the free ends 89c of the charging brush 89 tend to bend in the moving direction of the intermediary transfer belt 80. However, the sheet 90 is effective to confine the fur ends 89c of the brush 89b.

Therefore, even when there is a potential difference between the bias voltages applied to the charging brush 89 and to the charging roller 88, the insulation distance required to prevent the leak current may be smaller when the sheet 90 is provided than when there is no sheet 90.

In this embodiment, when the charging brush 89 contacts the intermediary transfer belt 80, the free end portion 90b of the sheet 90 also contacts to the intermediary transfer belt 80, but this is not inevitable, and the sheet 90 may be out of contact with the intermediary transfer belt 80.

As shown in FIG. 6, in this embodiment, when the charging brush 89 is spaced from the intermediary transfer belt 80, the free end portion 90b of the sheet 90 inclined at a angle θ regulates the entire brush 89b of the charging brush 89. From the foregoing, if there is a potential difference between the bias voltages applied to the charging brush 89 and to the charging roller 88, an electrostatic attraction force is produced, with the result that the free ends of the charging brush 89 tend to bend toward the charging roller 88, but the sheet 90 functions to confine the fur end 89c of the brush 89b, thus preventing the further movement toward the charging roller 88.

Therefore, even when there is a potential difference between the bias voltages applied to the charging brush 89 and to the charging roller 88, the insulation distance required to prevent the leak current may be smaller when the sheet 90 is provided than when there is no sheet 90.

### Embodiment 2

A second embodiment of the present invention will be described. In the description of the general arrangement of the image forming apparatus of this embodiment, the same reference numerals as in Embodiment 1 are assigned to the elements having the corresponding functions in this embodiment, and the detailed description thereof is omitted for simplicity.

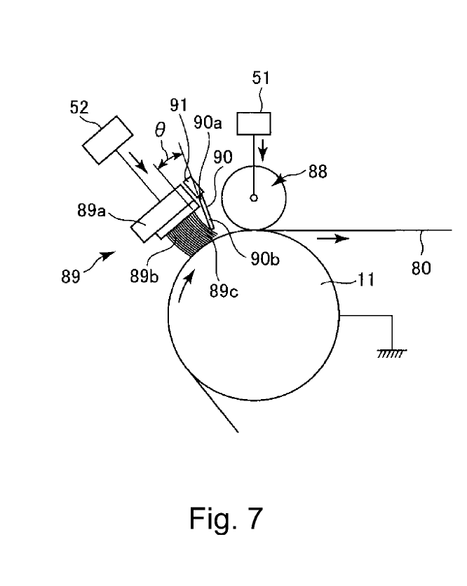

This embodiment is different from Embodiment 1 in that the relative positional relation between the charging brush 89 and the sheet 90 for regulating the attitude of the fur ends 89c of the charging brush 89 are different depending on whether they are in the contacted state or the spaced state. More particularly, in this embodiment, as shown in FIG. 7, even when the charging brush 89 is contacted to the intermediary transfer belt 80, the free end portion 90b of the sheet 90 does not contact the intermediary transfer belt 80.

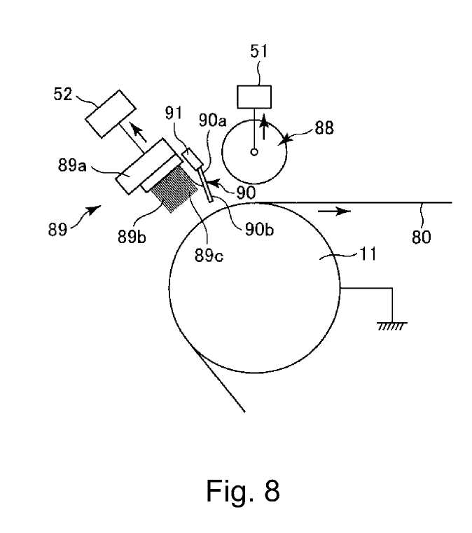

FIGS. 7 and 8 illustrate contacting and spacing operation state between the charging brush 89 and the intermediary transfer belt 80.

The sheet 90 is disposed downstream of the charging brush 89 with respect to the moving direction of the intermediary transfer belt 80, and the free end portion 90b of the sheet 90 is contacted to the brush 89b with an angle θ to regulate the attitude of the fur ends 89c, and the upper portion 90a thereof is fixed to the supporting member 91.

In this embodiment, the sheet 90 is fixed to the member 91 which is different from the member 89a to which the charging brush 89 is fixed. Therefore, even when the charging brush 89 is contacted to or spaced away from the intermediary transfer belt 80 by a contacting-spacing unit 52, the absolute position of the sheet 90 does not change.

Since the sheet 90 does not contact the intermediary transfer belt 80, there is no liability of the damage due to the sliding contact, and therefore, the rigid may be high, and therefore, the latitude for the material selection is wide.

As shown in FIG. 7, when the charging brush 89 is contacted to the intermediary transfer belt 80, the force is applied in the moving direction of the intermediary transfer belt 80, and therefore, the free ends 89c of the charging brush 89 tend to bend in the moving direction, but the sheet 90 is effective to confine the fur ends of the brush 89b.

Therefore, even when there is a potential difference between the bias voltages applied to the charging brush 89 and to the charging roller 88, the insulation distance required to prevent the leak current may be smaller when the sheet 90 is provided than when there is no sheet 90.

As shown in FIG. 8, when the charging brush 89 is spaced from the intermediary transfer belt 80, and there is a potential difference between the bias voltages applied to the charging brush 89 and to the charging roller 88, an electrostatic attraction force produces, and the free ends 89c of the brush 89b tend to bend toward the charging roller 88, but the sheet 90 is effective to confine the fur end 89c of the brush 89b.

Therefore, even when there is a potential difference between the bias voltages applied to the charging brush 89 and to the charging roller 88, the insulation distance required to prevent the leak current may be smaller when the sheet 90 is provided than when there is no sheet 90.

While the invention has been described with reference to the structures disclosed herein, it is not confined to the details set forth and this application is intended to cover such modifications or changes as may come within the purpose of the improvements or the scope of the following claims.

This application claims priority from Japanese Patent Application No. 171816/2010 filed Jul. 30, 2010 which is hereby incorporated by reference.

What is claimed is:

1. An image forming apparatus, comprising:
an image bearing member for carrying a toner image;
a rotatable intermediary transfer member;
a first transfer member for transferring the toner image formed on said image bearing member onto said intermediary transfer member at a first transfer position;
a second transfer member for transferring toner images transferred and superposed on said intermediary transfer member onto a transfer material at a second transfer position;
a charging member provided downstream of the second transfer position and upstream of the first transfer position with respect to the rotational moving direction of said intermediary transfer member;
a first voltage source portion for applying a voltage to said charging member;
a charging brush provided downstream of the second transfer position and upstream of said charging member with respect to the rotational moving direction;
a second voltage source portion for applying a voltage to said charging brush, wherein second voltage source portion is capable of applying voltage to said charging brush in a state that a voltage is applied to said charging member by first voltage source portion; and
a regulating member, provided between said charging member and said charging brush with respect to the rotational moving direction, for regulating a position of a brush of said charging brush.

2. An image forming apparatus according to claim 1, wherein said regulating member includes a sheet.

3. An image forming apparatus according to claim 2, wherein said sheet is polyurethane film.

4. An image forming apparatus according to claim 1, wherein a polarity of the voltage applied to said charging member by first voltage source portion and a polarity of the voltage applied to said charging brush by second voltage source portion are the same.

5. An image forming apparatus according to claim 4, wherein when second voltage source portion applies the voltage to said charging brush in a state that first voltage source portion applies a voltage to said charging member, an absolute value of the voltage applied to the charging brush by second voltage source portion is larger than an absolute value of the voltage applied to said charging member by first voltage source portion.

6. An image forming apparatus according to claim 1, further comprising a contacting-spacing unit for contacting and spacing said charging brush relative to said intermediary transfer member.

7. An image forming apparatus according to claim 6, wherein said regulating member moves together with said charging brush by said contacting-spacing unit.

8. An image forming apparatus according to claim 1, wherein said regulating member regulates an attitude of said brush charging member only when said brush charging member is spaced from said intermediary transfer member.

9. An image forming apparatus according to claim 1, wherein said developing unit includes a rotary type development unit carrying a plurality of such developing devices to bring a predetermined developing device to a developing position where it is opposed to said image bearing member to develop the electrostatic latent image on said image bearing member into a toner image.
